(19) United States
(12) Patent Application Publication
(10) Pub. No.: US 2019/0374939 A1
(43) Pub. Date: Dec. 12, 2019

(54) LIQUID SEPARATION DEVICE AND ITS METHOD OF USAGE

(71) Applicant: Autocell Biomedical Technology Co. Ltd., Taipei City (TW)

(72) Inventors: Yu-Tsang Lee, Taipei City (TW); Wen-Shan Chen, Changhua County (TW)

(21) Appl. No.: 16/001,935

(22) Filed: Jun. 7, 2018

(51) Int. Cl. B01L 3/00; B01D 21/26

(52) U.S. Cl. CPC B01L 3/5082; B01D 21/262; B01L 2300/123; B01L 2300/042; B01L 2300/0832

(57) ABSTRACT

A liquid separation device comprises a tubular container and a piston. The tubular container has an accommodating space for storing a liquid. A front end of the tubular container is gradually reduced to form a conical body. A column is protruded from a front end of the conical body. An opening is formed at a rear end of the tubular container. The piston is movably placed inside the tubular container from the opening and is made of flexible and elastic material which will expand and tighten the tubular container. A fixing column is disposed on the piston to facilitate the pressure on the fixed column to control the movement of the piston.

### BACKGROUND OF THE INVENTION

### Field of the Invention

The present invention relates to a liquid separation device and more particularly to a separation device applied for separating the composition of blood, increasing liquid separation efficiency, enhancing the collection quality of liquid composition, and effectively preventing contamination.

### Description of Related Art

Human blood mainly comprises a variety of compositions, such as plasma, erythrocyte, leukocyte, platelet, and so on. Each composition has different uses to maintain the normal functioning of human body and enable the human body to live a healthy life.

In general, blood rich in compositions can provide the whole body with complete needs, but in medical applications, sometimes a single composition of the blood is needed. For example, platelet can secrete various types of growth hormone that have favorable auxiliary effects on the tissue regeneration of articular cartilages. Therefore, it is necessary to implement the separation operation of the blood to collect the required compositions.

A common blood separation technique is to put the blood into a blood collection tube and rotate the blood collection tube by a centrifuge. Under the effect of centrifugal force, the main compositions of the blood are separated into three layers in the blood collection tube, wherein the upper layer is a light yellow plasma, the lower layer is a dark red erythrocyte, and the liquid in the middle layer interfaced between the upper and the lower layers is a light grey platelet-rich plasma, or PRP for short.

Because PRP has medical and commercial values, how to improve the collection efficiency and quality of the PRP has become a topic of considerable interest in the industry.

In the conventional techniques, such as the blood separation device with the Taiwan patent number M483797 provides a simplified structure of the blood separation device for improving the convenience of operation, increasing the precision of blood separation, and at the same time reducing the risk of blood contamination during the operational process.

However, the above-mentioned conventional technique employs a sleeve 30 which is a general cylindrical structure and does not have the efficacy of assisting PRP collection. Also, the conventional technique employs a push rod 11 for pushing a trough body 13 movement to obtain the required PRP. Therefore, the precision of this operation is limited and the PRP concentration obtained is also difficult to maintain.

The other conventional technique of the centrifugal tube structure with the Taiwan patent number 1490493 also provides a simplified structure of the blood separation device for improving the convenience of operation. The conventional technique comprises a tube 2 with a necking portion 21 in the middle. During operation, a push rod 42 is used to drive a piston 41 to gather the PRP on the necking portion 21, and then use a fine needle 6 to extract the PRP. However, the necking portion 21 of the tube 2 is obviously weak in structure and dangerous to fracture during operation. Also, the long and narrow necking portion 21 will definitely obstruct the separation of blood when the centrifuge rotates, resulting in the increase of operation time and the reduction of quality. Furthermore, the action of extracting the PRP by the fine needle 6 through an upper layered liquid may also cause the PRP to mix with the upper layered liquid to reduce the quality.
Therefore, it can be seen that conventional techniques still have room for improvements and urgently needs to be overcome by professionals in the industry.

### SUMMARY OF THE INVENTION

A primary object of the present invention is to provide a liquid separation device for separating and gathering up the liquid effectively, increasing the concentrations of the stratified liquid, facilitating the collection of the required liquid, and improving the quality of the liquid collection.

Another object of the present invention is to provide a liquid separation device with a hermetically and reliably sealed structure that will not contact to the outside during operation and can prevent contamination and avoid infection.

Another object of the present invention is to provide a liquid separation device for speeding up the separation process, and maintaining the freshness of the separated liquid to give full play to the efficacy of the separated liquid.

A liquid separation device provided by the present invention mainly comprises a tubular container and a piston.

The tubular container has an accommodating space disposed therein for storing the liquid to carry out the centrifugal force rotation operation of the centrifuge. A front end of the tubular container is gradually reduced to form a conical body and a column is protruded and extended from a front end of the conical body. A guiding passage penetrates through the column and a front end of the guiding passage forms a tubular opening. An opening is formed at a rear end of the accommodating space penetrated through the tubular container. A front end of the accommodating space extends to an inside of the conical body and connects with the guiding passage so that the tubular opening and the opening are communicated. The piston is movably placed inside the tubular container from the opening. The piston is made of a flexible and elastic material which will expand and tighten the tubular container when the piston is under pressure to maintain the air-tightness inside the accommodating space. A rear end of the piston is provided with a fixing column to facilitate the pressure on the fixed column to control the movement of the piston.

When using the above-mentioned structure, firstly, blood is placed into the accommodating space inside the tubular container at the time of use, and then the tubular container is placed in the centrifuge to carry out the centrifugal operation. Under the effect of centrifugal force, the blood is separated into three layers of upper, middle and lower. The upper layer is light yellow plasma, the lower layer is dark red erythrocytes, and the middle layer interfaced between the upper and the lower layers is light grey PRP. Further, a syringe is connected to the front end of the tubular container, and an inside rod of the syringe is pulled backward to draw out the upper layered plasma. Finally, another syringe is connected to the front end of the tubular container, and the fixing column is forced to push the PRP into the syringe to complete the collection of the PRP.

The invention is due to the setting of the conical body so that when the PRP is guided out from the tubular container for collection, the PRP will aggregate inside the conical body of the accommodating space. As such, the concentration of the PRP increases greatly, thereby increasing the collection rate of the PRP. A cone angle is formed between a rear end face of the conical body and a circumferential wall of the conical body. A preferred cone angle of the present invention is set in a range from 20 to 85 degrees.

The column can be tightly coupled with a front end of the syringe with common standard and an outer surface of the column can also be disposed with a thread for connecting with the syringe with the common standard, so that the front end of the syringe is deeply inserted into the guiding passage to reach a connecting end of the conical body and the column to increase the PRP concentration and to avoid contamination during collection. A front end of the column can also be connected with a three-way valve for connection operation.

Similarly, a tubular opening cap and a bottom cap are respectively disposed with a thread for correspondingly connecting with the thread on the outer surface of the column and a thread on an outer surface of the tubular container to enhance the air-tightness of the sealed tubular container.

Additionally, a push rod is penetratingly disposed at a center of the bottom cap of the present invention. A front end of the push rod is connected with the fixing column to drive the movement of the fixing column and the piston. The push rod and the fixing column are connected by threads. When the push rod and the fixing column are tightly coupled by the threads, the piston can be pushed and moved steadily.

A perforation is arranged at the center of the bottom cap to allow the push rod to pass through the perforation and connect with the fixing column. A position of the perforation is provided for supporting the push rod. Further, threads are disposed between the push rod and the through hole of the bottom cap so that the push rod can slowly rotate the piston by the threads and the push rod can move the piston more steadily and precisely, thereby further improving the quality of the PRP collection.

Wherein the push rod turns manually or electrically in order to move the piston.

Further, the piston is made of a flexible and elastic material, such as rubber, which will expand and tighten the tubular container when the piston is under pressure. Also, a buffer space is disposed between the piston and the fixing column to allow the piston to expand and deform easily when the piston is under pressure to maintain the air-tightness inside the accommodating space.

Furthermore, scales are disposed on surfaces of the tubular container, the conical body and the column, so that the collection volumes can be observed and calculated immediately during the PRP collection. The push rod is used to control stop positions of the piston for obtaining the different levels of the platelet-rich plasma including leukocyte-rich platelet-rich plasma and hypo-leukocyte platelet-rich plasma.

A convex lens is disposed on the column to magnify the connecting ends between different compositions of the blood so as to improve the quality of the PRP collection.

### BRIEF DESCRIPTION OF THE DRAWINGS

FIG. 1 is a perspective exploded view of a liquid separation device in accordance with the present invention;

FIG. 2 is a plane exploded view of the liquid separation device in accordance with the present invention;

FIG. 3 is a plane exploded sectional view of the liquid separation device in accordance with the present invention;

FIG. 4 is a plane sectional view of the liquid separation device being inserted with a push rod;

FIG. 5 is an operational flow chart of the liquid separation device in accordance with the present invention;

FIGS. 6A to 6D are plane sectional views of the liquid separation device showing the structural changes;

FIG. 7 is a plane view of the liquid separation device being disposed with a convex lens; and

FIG. 8 is a bar chart of the cone angle of the liquid separation device affecting the collection rate of the PRP.

### DETAILED DESCRIPTION OF THE INVENTION

The structure and the technical means adopted by the present invention to achieve the above and other objects can be best understood by referring to the following detailed description of the preferred embodiments and the accompanying drawings. However, the preferred embodiments are merely for explaining the present invention, and are not used to limit the present invention.

A liquid separation device provided by the present invention is mainly used for blood separation in order to collect PRP (platelet-rich plasma) for various applications. Certainly, it is not limited to blood separation; all devices for using in a centrifuge to carry out liquid composition separation belong to the protection scope of the present invention.

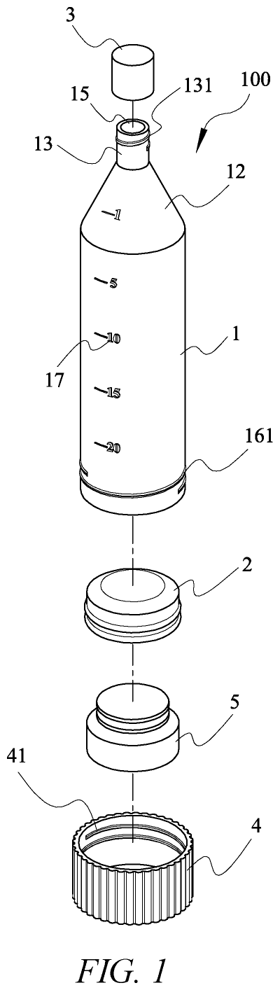

Please refer to FIGS. 1 to 4. A liquid separation device 100 provided by the present invention mainly comprises a tubular container 1 and a piston 2.

The tubular container 1 has an accommodating space 11 disposed therein for storing the liquid to carry out the operation of the composition separation by the centrifuge.

A front end of the tubular container 1 is gradually reduced to form a conical body 12 and a column 13 is protruded and extended from a front end of the conical body 12. A guiding passage 14 penetrates through the column 13 and a front end of the guiding passage 14 forms a tubular opening 15.

An opening 16 is formed at a rear end of the accommodating space 11 penetrated through the tubular container 1. A front end of the accommodating space 11 extends to an inside of the conical body 12 and connects with the guiding passage 14 so that the tubular opening 15 and the opening 16 are communicated. In practical use, a tubular opening cap 3 is capped on the tubular opening 15 of the column 13, and a bottom cap 4 is capped on the opening 16 of the tubular container 1 in order to seal the tubular container 1 hermetically for centrifugal operation.

The piston 2 is movably placed inside the tubular container 1 from the opening 16. The piston 2 is made of a flexible and elastic material which will expand and tighten the tubular container 1 when the piston is under pressure to maintain the air-tightness inside the accommodating space 11. A fixing column 5 is disposed at a rear end of the piston 2 so that the fixing column 5 can be conveniently pressured by a push rod 6 to control the movement of the piston 2.

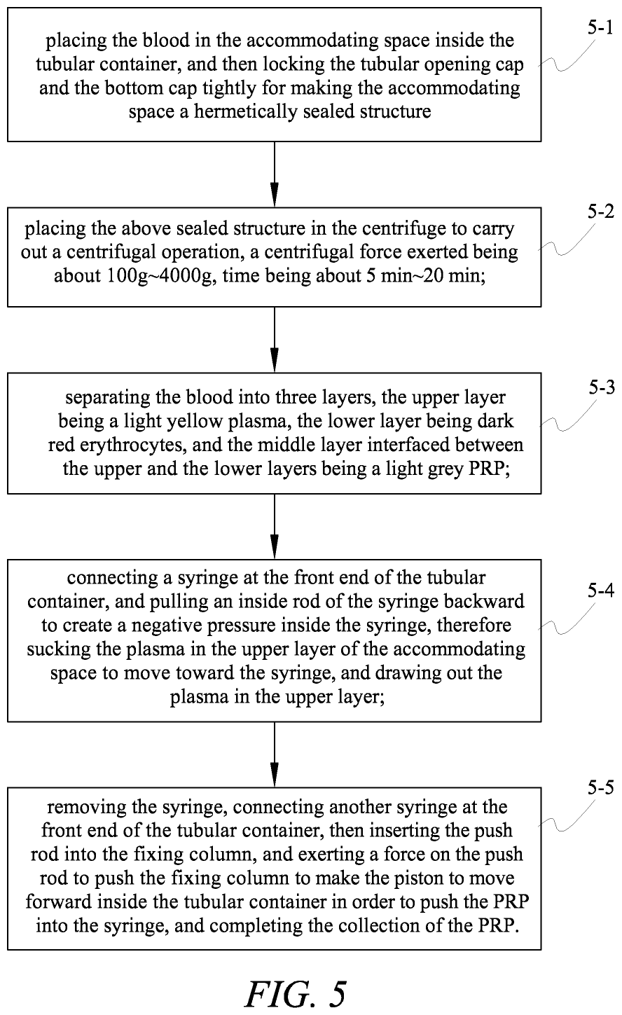

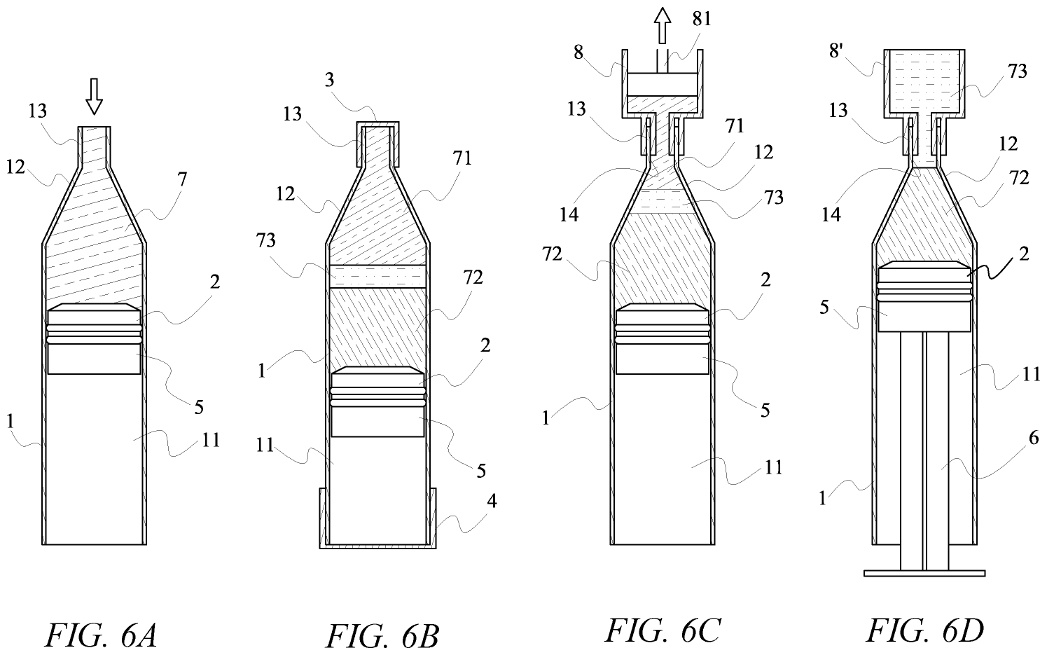

Please refer to FIGS. 5 to 6D. The steps of using the above liquid separation device 100 for blood 7 separation to collect PRP 73 is summarized as follows:

5-1: firstly, placing the blood 7 in the accommodating space 11 inside the tubular container 1 (FIG. 6A), and then locking the tubular opening cap 3 and the bottom cap 4 tightly for making the accommodating space 11 a hermetically sealed structure;

5-2: placing the above sealed structure in the centrifuge to carry out a centrifugal operation, a centrifugal force exerted being about 100 g˜4000 g, time being about 5 min˜20 min;

5-3: at this time, separating the blood 7 into three layers, the upper layer being a light yellow plasma 71, the lower layer being dark red erythrocytes 72, and the middle layer interfaced between the upper and the lower layers being a light grey PRP 73 (FIG. 6B);

5-4: connecting a syringe 8 at the front end of the tubular container 1, and pulling an inside rod 81 of the syringe 8 backward to create a negative pressure inside the syringe 8, therefore sucking the plasma 71 in the upper layer of the accommodating space 11 to move toward the syringe 8, and drawing out the plasma 71 in the upper layer (FIG. 6C); and

5-5: removing the syringe 8, connecting another syringe 8′ at the front end of the tubular container 1, then inserting the push rod 6 into the fixing column 5, and exerting a force on the push rod 6 to push the fixing column 5 to make the piston 2 to move forward inside the tubular container 1 in order to push the PRP 73 into the syringe 8′, and completing the collection of the PRP 73 (FIG. 6D).

It can be known from the above-mentioned liquid separation device 100 and steps that the present invention employs the syringes 8 and 8′ to draw out the blood 7 composition, or employs the piston 2 to squeeze out the blood 7 composition; adaptable dispositions are available to meet different requirements in order to obtain the required PRP 73 more conveniently and precisely.

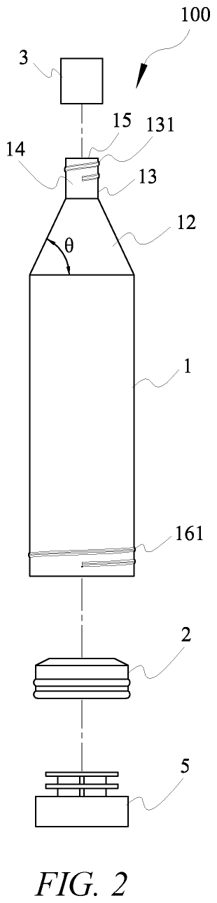

Please refer to FIGS. 1 and 2 again. One of the important characteristics of the present invention is due to the setting of the conical body 12, the PRP 73 is guided out from the tubular container 1 for collection, the PRP 73 will aggregate inside the conical body 12 of the accommodating space 11 because the front end of the tubular container 1 is gradually reduced. Therefore, the concentration of the PRP 73 increases greatly, thereby increasing the collection rate of the PRP 73.

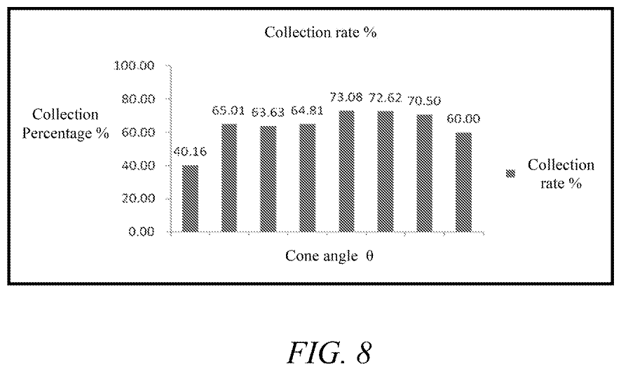

A cone angle θ is formed between a rear end face of the conical body 12 and a circumferential wall of the conical body 12. In order to obtain a preferred cone angle θ, the inventor performs experiments based on different cone angles θ, and the collection rates of the PRP 73 are shown in FIG. 8 and the following table:

| | | Collection |
|---|---|---|
| Number | Cone angle θ | rate % |
| 1 | 15 degrees | 40.16 |
| 2 | 25 degrees | 65.01 |
| 3 | 30 degrees | 63.63 |
| 4 | 45 degrees | 64.81 |
| 5 | 60 degrees | 73.08 |
| 6 | 65 degrees | 72.62 |
| 7 | 80 degrees | 70.50 |
| 8 | 90 degrees | 60.00 |

It can be known from the above list that the collection rate of the PRP 73 increases as the cone angle θ of the conical body 12 increases. A preferred cone angle θ of the present invention is set in a range from 20 to 85 degrees.

Please refer to FIGS. 6C and 6D again. The column 13 of the present invention is also convenient for collecting the PRP 73. The column 13 can be tightly coupled with a front end of the syringe 8 with common standard so that the front end of the syringe 8 is deeply inserted into the guiding passage 14 to reach a connecting end of the conical body 12 and the column 13 to increase the PRP 73 concentration during collection and to avoid contamination. A front end of the column 13 can also be connected with a three-way valve (not shown) for connection operation.

Similarly, as shown in FIGS. 1 to 3 and 6C to 6D, an outer surface of the column 13 can be disposed with a thread 131 for connecting with the syringe 8 with the common standard, and the thread 131 is used to enhance the air-tightness of the connection.

Please refer to FIGS. 1 to 3 again. The tubular opening cap 3 and the bottom cap 4 are respectively disposed with a thread 31 and a thread 41 for correspondingly connecting with the thread 131 of the outer surface of the column 13 and a thread 161 of an outer surface near the opening 16 of the tubular container 1 to enhance the air-tightness of the sealed tubular container 1.

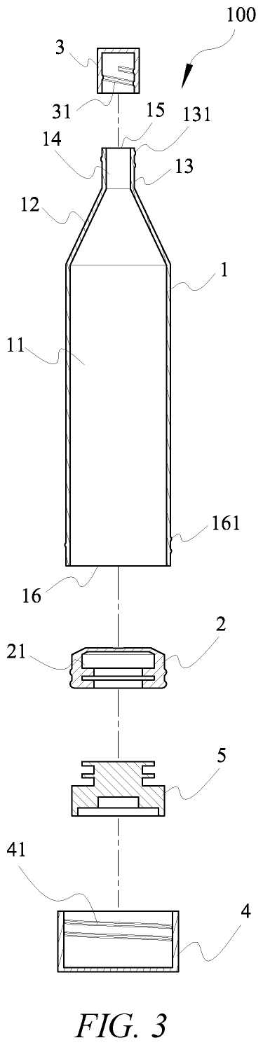

Please refer to FIGS. 3, 4 and 6D. A front end of the push rod 6 is connected with the fixing column 5 to drive the movement of the fixing column 5 and the piston 2. In order to avoid jiggling caused by an unreliable connection of the push rod 6 and the fixing column 5 and thus affecting the quality of collecting the PRP 73, the push rod 6 and the fixing column 5 are connected by threads 51 and 61. When the push rod 6 and the fixing column 5 are tightly coupled by the threads 51 and 61, the piston 2 can be pushed and moved steadily to enhance the quality of the PRP 73 collection.

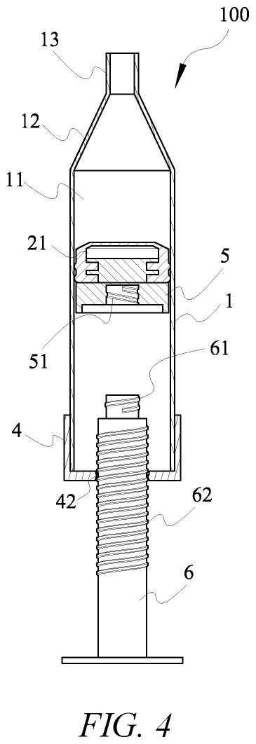

As shown in FIG. 4, the push rod 6 is a slender rod, even connected by the thread 61, the push rod 6 wobbling may still affect the collection of the PRP 73; therefore, a perforation is provided in the center of the bottom cap 4 to allow the push rod 6 to pass through the perforation and connect with the fixing column 5. The position of the perforation is used to provide for supporting the push rod 6 so that the push rod 6 can directly push the fixing column 5 without relying on the threads 51 and 61. In this way, the push rod 6 can be pushed more steadily, thereby improving the quality of the PRP 73 collection.

Alternatively, threads 62 and 42 are respectively disposed between the push rod 6 and the perforation of the bottom cap 4 so that the push rod 6 can slowly rotate the piston 2 by the threads 62 and 42. In this way, the push rod 6 can move the piston 2 more steadily and precisely, thereby further improving the quality of the PRP 73 collection.

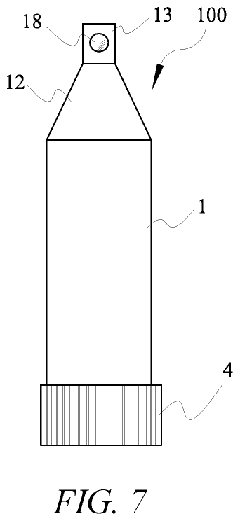

Additionally, please refer to FIGS. 3 and 4. The piston 2 is made of a flexible and elastic material, such as rubber or silicone, which will expand and tighten the tubular container 1 when the piston 2 is under pressure. The invention further sets a buffer space 21 disposed between the piston 2 and the fixing column 5 to allow the piston 2 to expand and deform more easily when the piston 2 is under pressure to maintain the air tightness in the accommodating space 11. Further, as shown in FIG. 1, in order to facilitate the calculation of the volume of the PRP 73 composition collected, scales 17 are disposed on surfaces of the tubular container 1, the conical body 12 and the column 13, so that the collection volume can be calculated immediately during the PRP 73 collection. In combination with the scales 17 arranged on the surfaces of the liquid separation device 100 and the use of the push rod 6 to control stop positions of the piston 2, different levels of the platelet-rich plasma including leukocyte-rich platelet-rich plasma and hypo-leukocyte platelet-rich plasma can be obtained. As shown in FIG. 7, a convex lens 18 is arranged on the column 13 to magnify the connecting ends between different compositions of the blood 7 so as to improve the quality of the PRP 73 collection.

Through practical operation, the above-mentioned liquid separation device 100 of the present invention has proved indeed to increase the convenience of collecting the PRP 73, promote the working efficiency, and greatly improve the quality of the PRP 73 collection. Therefore, the applications of the PRP 73 can better meet the requirements, while further reducing the possibility of contamination and improving the security.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A liquid separation device, comprising:
a tubular container, a piston, a bottom cap and a tubular opening cap;
wherein the tubular container has a gradually reduced front end to form a conical body, a column that is protruded and extended from a front end of the conical body, the tubular container that has an accommodating space disposed therein, an opening that is formed at a rear end of the accommodating space penetrated through the tubular container, a guiding passage that is formed at a front end of the accommodating space extended to an inside of the conical body and penetrated through an inside of the column, and a tubular opening that is formed at a front end of the guiding passage penetrated through the column;
the piston that is movably placed inside the tubular container from the opening and is made of a flexible and elastic material, and a fixing column that is disposed at a rear end of the piston;
the bottom cap that is capped on an end of the opening of the tubular container; and
the tubular opening cap that is capped on an end of the tubular opening of the column.

2. The liquid separation device as claimed in claim 1, wherein scales are disposed on surfaces of the tubular container, the conical body and the column.

3. The liquid separation device as claimed in claim 1, wherein a cone angle is formed between a rear end face of the conical body and a circumferential wall of the conical body, the cone angle is set in a range from 20 to 85 degrees.

4. The liquid separation device as claimed in claim 1, wherein threads are respectively disposed on an outer surface of the column and an outer surface of the tubular container.

5. The liquid separation device as claimed in claim 1, wherein a convex lens is disposed on the column.

6. The liquid separation device as claimed in claim 1, wherein a push rod is penetratingly disposed at a center of the bottom cap, a front end of the push rod is connected with the fixing column to drive the movement of the fixing column and the piston.

7. The liquid separation device as claimed in claim 6, wherein the push rod and the fixing column are connected by threads.

8. The liquid separation device as claimed in claim 6, wherein the push rod directly drives the piston, threads are disposed between the push rod and the bottom cap so that the push rod is slowly rotated with the threads to move the piston steadily and precisely.

9. The liquid separation device as claimed in claim 1, wherein a buffer space is disposed between the piston and the fixing column to allow the piston to expand and deform easily when the piston is under pressure.

10. A method of usage of a liquid separation device, comprising steps of:
a. placing blood in a liquid separation device and capping the liquid separation device in order to seal it;
b. placing the liquid separation device in a centrifuge to carry out a centrifugal operation;
c. separating the blood into two distinct layers, the upper layer being a light yellow plasma, the lower layer being dark red erythrocytes, and forming a thin layered light grey vaporous area at a boundary between the upper and the lower layers, the light grey vaporous area being platelet-rich plasma (PRP);
d. removing the plasma in the upper layer of the liquid separation device by connecting a syringe with the tubular opening at a front end of the liquid separation device, pulling an inside rod of the syringe backward to create a negative pressure inside the syringe, and sucking the plasma in the upper layer of the liquid separation device to flow toward the syringe;
e. drawing out the platelet-rich plasma by connecting the 5 ml syringe with the tubular opening at the front end of the liquid separation device, inserting the push rod from a rear end of the liquid separation device, turning the push rod along the threads to push the piston forward and to slide toward the end of the tubular opening in order to collect the light grey vaporous area at the boundary between the upper and the lower layers; and
f. using the scales on the surfaces of the liquid separation device and using the push rod to control stop positions of the piston for obtaining the different levels of the platelet-rich plasma including leukocyte-rich platelet-rich plasma and hypo-leukocyte platelet-rich plasma.
